(19) United States
(12) Patent Application Publication
(10) Pub. No.: US 2015/0120688 A1
(43) Pub. Date: Apr. 30, 2015

(54) DATA PROCESSING APPARATUS, DATA PROCESSING METHOD, AND NON-TRANSITORY COMPUTER READABLE MEDIUM

(71) Applicant: FUJI XEROX CO., LTD, Tokyo (JP)

(72) Inventors: Hirochika SHIONOIRI, Kanagawa (JP); Kohshiro INOMATA, Kanagawa (JP); Fumihisa SUZUKI, Kanagawa (JP); Yosuke KINOSHITA, Kanagawa (JP); Yasushi AMANO, Kanagawa (JP); Hideo FUJII, Kanagawa (JP)

(73) Assignee: FUJI XEROX CO., LTD, Tokyo (JP)

(21) Appl. No.: 14/294,725

(22) Filed: Jun. 3, 2014

(30) Foreign Application Priority Data
Oct. 25, 2013 (JP) 2013-222242

(51) Int. Cl. G06F 17/30

(52) U.S. Cl. CPC G06F 17/30386
USPC 707/705

(57) ABSTRACT

A data processing apparatus includes an extraction unit that extracts trial data that is extracted from contents of original data and is responsive to a process to be provided, a first transmission unit that transmits the trial data to a plurality of process providing units, an evaluation unit that receives and evaluates trial results of processes that the process providing units have performed on the transmitted trial data, and a selecting unit that selects from the plurality of process providing units a process providing unit that is to provide the original data, according to an evaluation result by the evaluation unit.

### CROSS-REFERENCE TO RELATED APPLICATIONS

This application is based on and claims priority under 35 USC 119 from Japanese Patent Application No. 2013-222242 filed Oct. 25, 2013.

### BACKGROUND

(i) Technical Field

The present invention relates to a data processing apparatus, a data processing method, and a non-transitory computer readable medium.

(ii) Related Art

Services to provide, via a network, computer resources prepared by users themselves are available. Such services are also referred to as cloud service.

### SUMMARY

According to an aspect of the invention, there is provided a data processing apparatus including an extraction unit that extracts trial data that is extracted from contents of original data and is responsive to a process to be provided, a first transmission unit that transmits the trial data to multiple process providing units, an evaluation unit that receives and evaluates trial results of processes that the process providing units have performed on the transmitted trial data, and a selecting unit that selects from the multiple process providing units a process providing unit that is to provide the original data, according to an evaluation result by the evaluation unit.

### BRIEF DESCRIPTION OF THE DRAWINGS

Exemplary embodiments of the present invention will be described in detail based on the following figures, wherein:

FIG. 1 illustrates an example of a configuration of a data processing system;

FIG. 2 is a block diagram illustrating a hardware configuration of a data processing apparatus;

FIG. 3 is a functional block diagram illustrating elements of the data processing apparatus;

FIG. 4 illustrates an example of a mapping table listing transmission destinations of original data;

FIG. 5 is a functional block diagram illustrating the data processing apparatus;

FIG. 6 is a flowchart illustrating an example of a trial process;

FIG. 7 is a flowchart illustrating an example of an execution process;

FIG. 8 is a functional block diagram illustrating the data processing apparatus;

FIG. 9 illustrates an example of a security level determination table;

FIG. 10 illustrates an example of a safety level determination table;

FIG. 11 is a flowchart illustrating an example of the execution process;

FIG. 12 is a functional flowchart illustrating the data processing apparatus; and

FIG. 13 is a flowchart illustrating an example of the trial process.

### DETAILED DESCRIPTION

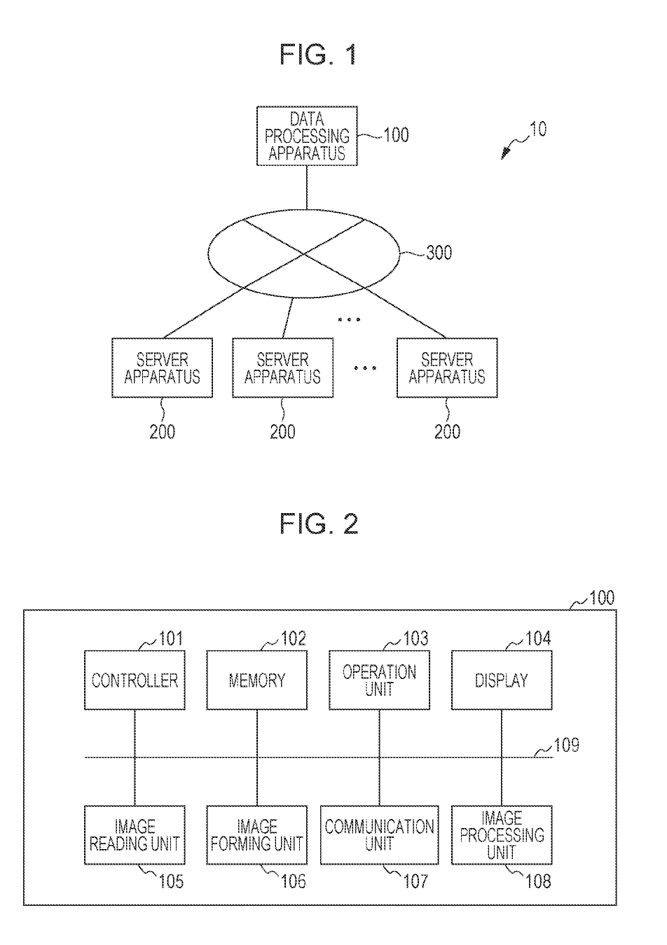

FIG. 1 illustrates an example of a configuration of a data processing system 10 as an exemplary embodiment of the present invention. The data processing system 10 performs data processing through cloud service. The data processing refers to image processing and text processing and includes optical character recognition (OCR), translation of a document, and difference detection between documents. The cloud service refers to a service that is provided using cloud computing. In the context of the exemplary embodiment, the cloud service refers to a service that executes data processing via a network.

The data processing system 10 includes a data processing apparatus 100 and multiple server apparatuses 200 with all these apparatuses connected via a communication line 300 (such as the Internet). The data processing system 10 includes a single data processing apparatus 100 as illustrated in FIG. 1 but may include two or more data processing apparatuses 100. The data processing system 10 may include another computer such as a personal computer.

The server apparatus 200 is a computer that provides the cloud service. The server apparatus 200 is an example of a providing unit that provides a different service (process). Services provided by the server apparatus 200 include multiple types of services, and the same type of service may be provided by multiple providers. If the multiple providers provide the same type of service, service quality may be different from provider to provider. For example, if a document translation service is provided, translation accuracy and translation languages may be different from provider to provider.

The data processing apparatus 100 is a computer that functions as a client apparatus to the server apparatus 200, and that transmits data to be processed (hereinafter referred to as original data) to the server apparatus 200. In the exemplary embodiment, the data processing apparatus 100 is an image forming apparatus that has a function of reading a document and generating image data of the read document, and a function of forming an image represented by the image data.

FIG. 2 is a block diagram illustrating a hardware configuration of the data processing apparatus 100. As illustrated in FIG. 2, the data processing apparatus 100 includes a controller 101, a memory 102, an operation unit 103, a display 104, an image reading unit 105, an image forming unit 106, a communication unit 107, and an image processing unit 108. These elements of the data processing apparatus 100 are connected to a bus 109, and exchange a variety of data via the bus 109.

The controller 101 controls each element of the data processing apparatus 100. The controller 101 includes a central processing unit (CPU), and a recording medium (first memory) such as a read-only memory (ROM) and a random-access memory (RAM). The CPU reads a control program stored on the ROM, and executes the control program using the RAM as a working area. By executing the control program, the controller 101 forms an image on a paper sheet, generates image data of a document by reading the document, and communicates with another apparatus via the communication line 300.

The memory 102 stores data. The memory 102 includes a recording medium (second memory), such as a hard disk or a flash memory. The memory 102 stores data received via the communication unit 107 and data generated by the data processing apparatus 100. The memory 102 may also include a removable recording medium, such as a memory card or a universal serial bus (USB) memory, and a unit that reads and writes data on the recording medium.

The operation unit 103 receives an operation of a user. The operation unit 103 includes controls (a button, a key, and the like), and supplies to the controller 101 a control signal responsive to a control pressed by the user. The operation unit 103 includes the display 104 and a sensor overlaid on a display screen of the display 104. The operation unit 103 may be a touchpanel that supplies to the controller 101 a control signal responsive to a location pressed by the user.

The display 104 displays information. The display 104 may include a liquid-crystal display. The display 104, controlled by the controller 101, displays a menu screen for use in operation of the data processing apparatus 100, and data related to the data processing apparatus 100.

The image reading unit 105 reads a document and converts the read document into image data. The image reading unit 105 includes an image reader that optically reads a document, and generates the image data representing the image of the read document. The image reading unit 105 supplies the generated image data to the image processing unit 108.

The image forming unit 106 forms an image. The image forming unit 106 includes an image forming mechanism that forms a toner image on a recording medium, such as a paper sheet in an electrophotographic method. The image forming mechanism is not limited to the electrophotographic method. Another recording method such as an ink-jet recording method may be employed.

The communication unit 107 transmits and receives data. The communication unit 107 is connected to the communication line 300, and functions as a communication interface that communicates with another apparatus connected to the communication line 300.

The image processing unit 108 performs image processing on the image data. The image processing refers to color correction and gradation correction. The image processing unit 108 supplies image data having undergone the image processing to the image forming unit 106.

The configuration of the data processing system 10 has been described. With the data processing system 10, the user may use the cloud service via the data processing apparatus 100. For example, through the cloud service, the user may process the image data that the image reading unit 105 provides by scanning a document, and may receive the processed data. The user may then form on a paper sheet an image responsive to the processed data or transfer the image to another apparatus.

Upon receiving the original data from the data processing apparatus 100, the server apparatus 200 processes the original data by executing data processing responsive to a service available thereon. The cloud services provided in the exemplary embodiment includes three types, namely, an “OCR service”, a “translation service”, and a “difference detection service”.

The OCR service recognizes characters included in an image represented by the image data, and outputs text data representing the recognized characters. The translation service recognizes a character string of a specific language included in the original data that is obtained by scanning a document, translates the character string of the specific language into a character string in another specific language and outputs the translated character string. The languages translated in the translation service may be selected by the user. The difference detection service determines a difference between two pieces of data as original data. The difference herein may be a character difference (such as a wrong character or a missing character), a difference in image or color, or a difference (displacement) in character position or image position.

The data processing apparatus 100 performs a cloud service trial before actually using the cloud service. The cloud service trial may be performed using sample data. The sample data may be data different from the original data and prepared beforehand or may be part of the original data. Based on a trial result on the sample data, the data processing apparatus 100 determines the transmission destination of the original data, and causes the user to select the service to be used (in other words, to select a provider).

The trial of the data processing apparatus 100 is not limited to any timing. For example, the data processing apparatus 100 may perform the trial at a periodic timing, for example, once a day, or every several hours. The data processing apparatus 100 may also perform the trial at a switch-on. The data processing apparatus 100 may also perform the trial each time the data processing apparatus 100 receives the original data from the user.

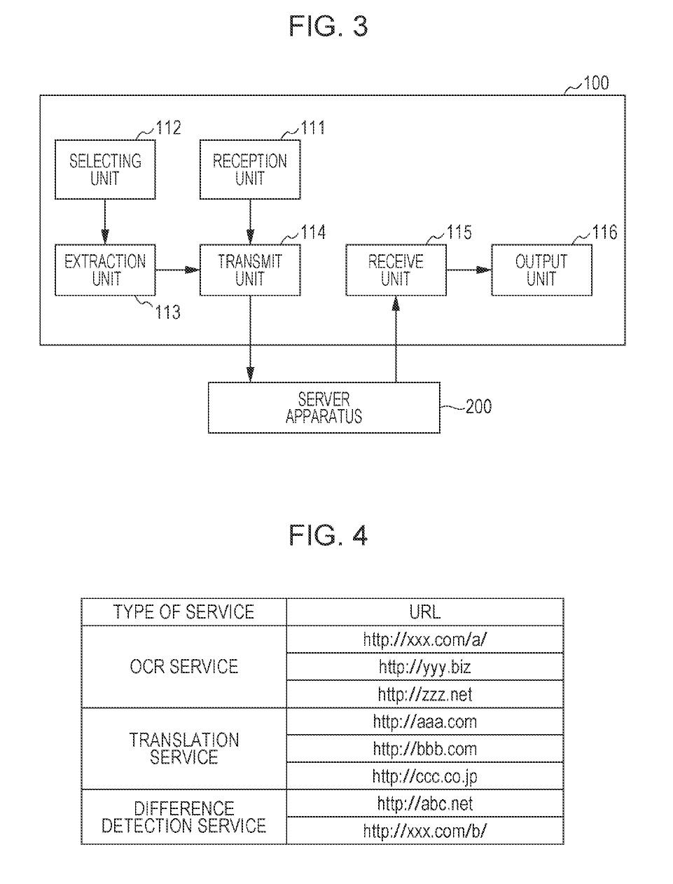

FIG. 3 is a functional block diagram illustrating elements of the data processing apparatus 100. The elements illustrated in FIG. 3 are common to each of the operation examples. When the controller 101 performs the control program, the data processing apparatus 100 implements a reception unit 111, a selecting unit 112, an extraction unit 113, a transmit unit 114, a receive unit 115, and an output unit 116.

The reception unit 111 receives the original data. More specifically, the reception unit 111 receives data as a target of the cloud service. The reception unit 111 receives as the original data the image data that is generated by the image reading unit 105 and then image-processed by the image processing unit 108. Alternatively, the reception unit 111 may receive the original data from another computer via the communication line 300, or reads, as the original data, data stored on a removable medium. Note that the reception unit 111 includes a function that decrypts the original data if the original data is encrypted.

The selecting unit 112 selects a type (kind) of service. For example, the selecting unit 112 selects the type of cloud service to be used by the user in response to an operation of the user. The selecting unit 112 presents three types of service options available, including the “OCR service”, the “translation service”, and the “difference detection service”, and then prompts the user to select one of these service options. The selecting unit 112 may select the type of service based on the kind of the original data (such as a data format) rather than in response to the operation by the user.

The extraction unit 113 extracts sample data. The extraction unit 113 extracts the sample data corresponding to the cloud service to be provided to the user. The sample data to be extracted by the extraction unit 113 may be different from type to type of the cloud service.

The transmit unit 114 controls transmission of data. More specifically, the transmit unit 114 controls the transmission of the data to the provider that provides the cloud service (namely, the server apparatus 200). More in detail, the transmit unit 114 includes a unit (first transmission unit) that transmits the sample data extracted by the extraction unit 113 and a unit (second transmission unit) that transmits the original data received by the reception unit 111. The transmit unit 114 transmits the data via the communication unit 107 by controlling the communication unit 107.

FIG. 4 illustrates an example of a mapping table listing transmission destinations of the original data. The transmit unit 114 determines the server apparatus 200 as the destination of the original data or the service based on the mapping table. As illustrated in FIG. 4, the mapping table lists in an associated form the type of service, and a uniform resource locator (URL) indicating the server apparatus 200 as the destination or the service. The mapping table indicates that the providers providing the OCR service are three companies, and the three companies are respectively identified URLs “http://xxx.com/a/”, “http://yyy.biz”, and “http:/zzz.net”. Note that different types of cloud service is provided by the same provider (such as http://xxx.com) as illustrated in FIG. 4.

The receive unit 115 controls reception of data. The receive unit 115 receives data transmitted from the server apparatus 200 via the communication unit 107. The data received by the communication unit 107 includes data indicating a trial result of the cloud service and data indicating an execution result of the cloud service.

The output unit 116 outputs data. For example, the output unit 116 outputs the trial result (or the execution result) of the service received by the receive unit 115. In the present exemplary embodiment, the outputting operation of the output unit 116 includes visualization of the data to allow the user to visually recognize the data. More specifically, the outputting operation includes a display operation of the display 104 and an image forming operation of the image forming unit 106. The operation of the output unit 116 is not limited to these operations. The output unit 116 may transfer the data to another apparatus (not illustrated), or store the data as a file on the memory 102.

Some of the elements of FIG. 3 do not necessarily have to be included in the data processing apparatus 100. For example, if only one type of service is provided, the selecting unit 112 may be dispensed with. If the trial result (or the execution result) of the service is not visualized (for example, if the data processing apparatus 100 performs an evaluation operation as in a first operation example to be described below), the output unit 116 may also be dispensed with.

The data processing apparatus 100 in this configuration performs the trial operation of the cloud service using the sample data. More in detail, the data processing apparatus 100 operates in the operation examples described below. The data processing apparatus 100 may be implemented to be operative in only one of the operation examples, but may be also be implemented to be operative in any one of the operation examples.

### First Operation Example

In a first operation example, the user registers the sample data. Furthermore in the first operation example, the data processing apparatus 100 registers the criteria data representing a criterion applied to the execution result of the cloud service performed on the sample data, and evaluates the trial result of the sample data according to the criteria data.

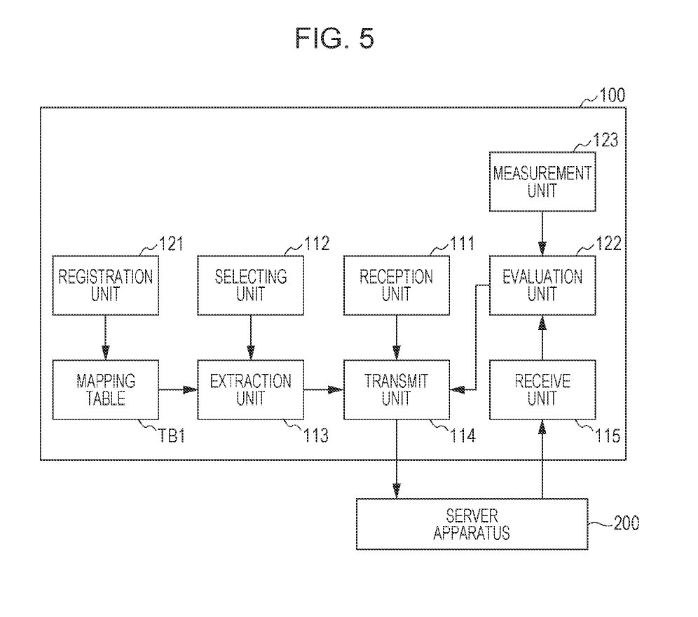

FIG. 5 is a functional block diagram illustrating the data processing apparatus 100 in the first operation example. In FIG. 5, each element having the same reference number as the one in FIG. 3 has the same function (this is true of the following operation examples). In the first operation example, the data processing apparatus 100 performs functions of a registration unit 121, an evaluation unit 122, and a measurement unit 123 in addition to the functions of the reception unit 111, the selecting unit 112, the extraction unit 113, the transmit unit 114, and the receive unit 115.

The registration unit 121 registers the cloud service. The registration unit 121 receives a registration of a new provider other than an existing provider, and includes the new provider as a transmission destination of the sample data (and the original data). More specifically, the registration unit 121 receives the registration of service by adding in the mapping table TB1 (see FIG. 4) the URL of the new provider and the type of the service provided by the new provider.

If the type of the cloud service to be registered is new, in other words, if the cloud service of a type not yet registered is to be registered, the registration unit 121 receives the sample data of the type and the registration of the criteria data together. The sample data typically used is data that is used to appropriately evaluate the cloud service on a per type basis. The criteria data to be used is data that results in an appropriate execution result of the cloud service on a per type basis. Any type of criteria data may be used as long as the criteria data is usable when the evaluation unit 122 performs the evaluation operation. The sample data and the criteria data are stored together with the mapping table TB1 on the memory 102. The registration operation using the registration unit 121 may be performed by the user. Alternatively, the registration operation using the registration unit 121 may be performed by the administrator of the data processing apparatus 100.

The evaluation unit 122 evaluates the trial result of the cloud service performed on the sample data. In other words, the evaluation unit 122 evaluates the quality of the cloud service of each provider. The evaluation unit 122 evaluates the trial result received by the receive unit 115 according to the criteria data. The evaluation method of the evaluation unit 122 is different from type to type of service. For example, if the service is the OCR service, the evaluation unit 122 evaluates the trial result according to accuracy of character recognition, namely, a rate of correct recognition of the characters. If the service is the translation service, the evaluation unit 122 evaluates the trial result according to a match rate with a character string indicated by the criteria data (in other words, a match rate of a translated sentence with the sample data). Alternatively, the evaluation unit 122 may reference a measurement result from the measurement unit 123, and may evaluate the trial result based on the measurement result.

The measurement unit 123 measures time from transmission of the sample data to reception of the trial result (hereinafter referred to as a “trial time duration”). More specifically, the measurement unit 123 measures speed at which the service is provided. If the speed of the service is one of the indexes of quality, the evaluation unit 122 evaluates the trial result of the service based on the criteria data and the trial time duration. Note that the evaluation unit 122 does not necessarily have to include the speed of the service as the index of quality.

In the first operation example, the transmit unit 114 determines the transmission destination of the original data based on the evaluation result of the evaluation unit 122. For example, the transmit unit 114 may transmit the original data to the server apparatus 200 of the provider whose evaluation result provided by the evaluation unit 122 is best.

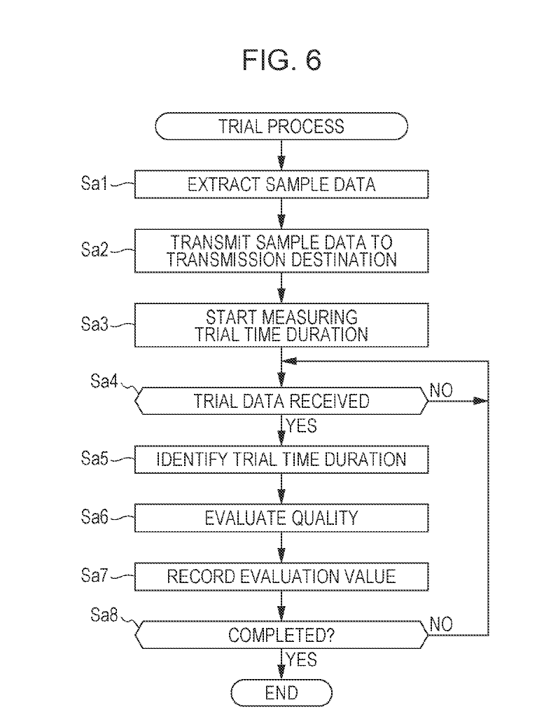

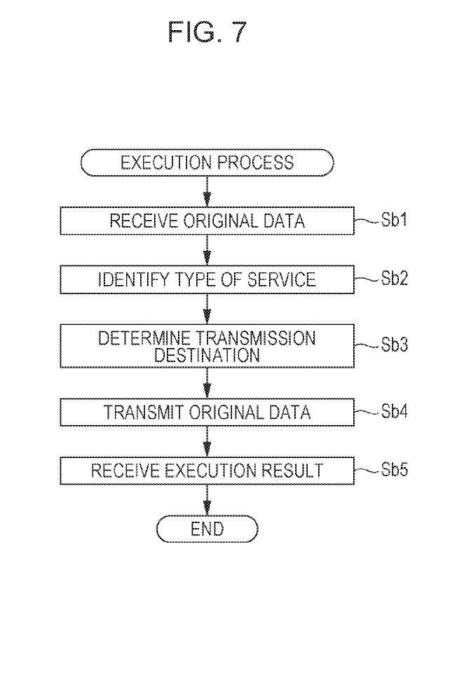

FIG. 6 and FIG. 7 are flowcharts illustrating examples of the processes performed by the data processing apparatus 100 in the first operation example. FIG. 6 is a flowchart illustrating an example of a process of the cloud service performed on a trial basis on the sample data (hereinafter referred to as a “trial process”). FIG. 7 is a flowchart illustrating an example of a process of the cloud service performed on the original data (hereinafter referred to as an “execution process”).

The trial process may be performed at any appropriate timing independently of the execution process, but the trial process may be performed (prior to or subsequent to the execution process) each time the execution process is performed. Considering that the contents of the cloud service are appropriately modified (improved) on a per provider basis, the trial process is desirably performed prior to each execution process in order to result in more accurate evaluation result. The trial process is to be performed on each type of the cloud service, but the trial process may be performed collectively for all the types.

In the trial process of FIG. 6, the controller 101 in the data processing apparatus 100 extracts the sample data corresponding to the type of the cloud service to be performed (step Sa1). The controller 101 extracts the sample data associated with the type of the cloud service to be performed out of the sample data stored on the memory 102.

The controller 101 transmits the sample data extracted in step Sa1 to the transmission destination corresponding to the type of the cloud service to be performed (i.e., the server apparatus 200) (step Sa2). The controller 101 identifies the URL of the transmission destination by referencing the mapping table stored on the memory 102, and transmits the sample data to the URL. When transmitting the sample data, the controller 101 also starts measuring the trial time duration (step Sa3). If there are multiple transmission destinations of the same service, the controller 101 transmits the sample data to each of the transmission destinations.

If the sample data is transmitted to the multiple transmission destinations, the controller 101 evaluates the trial results in the order of reception thereof. More specifically, the controller 101 determines whether data indicating the trial result (hereinafter referred to as “trial data”) has been received (step Sa4). The controller 101 repeats this operation until the trial data has been received. Upon receiving the trial data from a transmission destination, the controller 101 ends the measurement of the trial time duration of the transmission destination, and then identifies the trial time duration (step Sa5).

The controller 101 evaluates the quality of the cloud service provided by the provider at the transmission destination based on the trial data and trial time duration (step Sa6). The controller 101 evaluates the quality of the service by comparing the trial data with the criteria data. In accordance with a predetermined rule, the controller 101 evaluates the quality of the cloud service, and quantizes the evaluation result. The controller 101 records the quantized evaluation result on the memory 102 (step Sa7). The evaluation result recorded in step Sa7 is hereinafter referred to as an “evaluation value”.

The evaluation method of the cloud service is not limited to any particular method. The following methods may be available, for example. If the cloud service as an evaluation target is the OCR service, the controller 101 compares text data obtained from the trial data (a character recognized in the OCR service) with text data obtained from the criteria data registered beforehand, and calculates a match rate of character as the evaluation value. The match rate herein is a ratio of the number of matched characters to the total number of characters contained in the text data. In this case, the controller 101 divides the trial data into segments according to the degree of difficulty of an OCR process, and calculates the evaluation value by attaching to each segment a weight responsive to the degree of difficulty. The controller 101 comprehensively evaluates the cloud service by adding to (or subtracting from) the thus-obtained evaluation value a value responsive to the trial time duration. Alternatively, the controller 101 may evaluate the cloud service by using only the evaluation value based on the trial data without accounting for the trial time duration.

Upon recording the evaluation value, the controller 101 determines whether to end the trial process (step Sa8). More specifically, the controller 101 determines whether all the transmission destinations to which the sample data has been transmitted have been evaluated. If all the transmission destinations to which the sample data has been transmitted have been evaluated, the controller 101 completes the trial process. If there is still a transmission destination to be evaluated, the controller 101 repeats operations starting with step Sa4. More specifically, the controller 101 determines whether the trial data has been received from the transmission destination still to be evaluated. Upon receiving the trial data, the controller 101 evaluates the cloud service of the provider of that transmission destination.

The data processing apparatus 100 executes the trial process in this way to be ready for the execution process to be performed later. Upon receiving the original data from the user, the data processing apparatus 100 starts the execution process. In the execution process, the data processing apparatus 100 uses the evaluation value obtained in the trial process.

In the execution process of FIG. 7, the controller 101 in the data processing apparatus 100 receives the original data from the user (step Sb1). The original data may be obtained by scanning the document using the image reading unit 105 as previously described. Alternatively, the original data may be obtained from another computer via the communication line 300 or may be retrieved from a removable medium. The controller 101 may also receive the type of the process to be performed on the received original data. The controller 101 thus identifies the type of the cloud service to be performed (step Sb2).

The controller 101 determines the transmission destination of the original data (step Sb3). The controller 101 references the evaluation values of the multiple transmission destinations concerning the cloud service of the type specified by the user, and determines a transmission destination of the original data based on the evaluation values. For example, the controller 101 determines a transmission destination having the highest evaluation value as the transmission destination of the original data. The controller 101 transmits the original data to the transmission destination thus determined (step Sb4), and then receives data indicating an execution result of the cloud service performed on the transmitted original data (step Sb5).

Since the sample data is registered by the user in the exemplary embodiment, the evaluation unit 122 does not necessarily have to perform the evaluation operation. For example, the data processing apparatus 100 outputs the trial result of the service for the user to evaluate the trial result so that the user may decide the transmission destination of the original data. Alternatively, the data processing apparatus 100 may output the evaluation value and the trial time duration so that the user may select the transmission destination to be used.

In this operation example, the user is free from having to select the provider as the transmission destination in the use of the cloud service. Even if the contents and quality of the cloud service of each provider change daily and hourly, the user may enjoy the cloud service provided by the provider at high quality level available at the time.

The data processing apparatus 100 prepares the sample data on each type of the cloud service. In comparison with the case that the sample data is not different from type to type of the cloud service, this increases the possibility that the quality of each type is more accurately evaluated. This is because the sample data appropriate for evaluation is different from type to type of the provided service. For example, in the sample data, one type of service may be desirably character-oriented while the other type of service may be desirably image-oriented.

### Second Operation Example

In a second operation example, the security level of the original data and the safety level of the cloud service are determined, and the transmission destination of the original data is decided based on the determination results. The second operation example may be combined with the first operation example. In the discussion that follows, operation steps identical to those of the first operation example are omitted as appropriate.

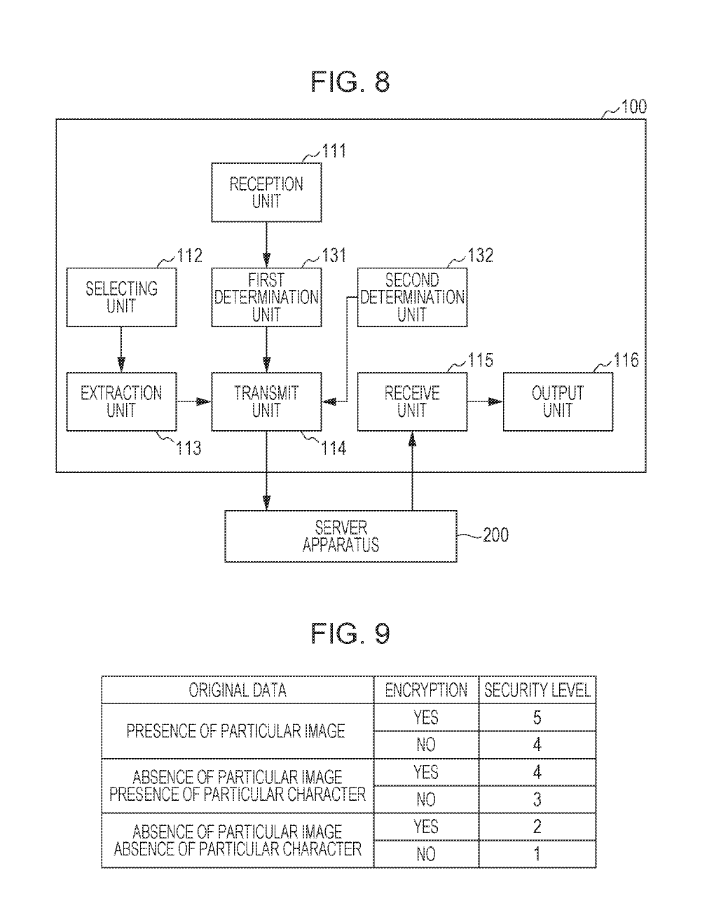

FIG. 8 is a functional block diagram illustrating the data processing apparatus 100 in the second operation example. The data processing apparatus 100 performs functions of a first determination unit 131, and a second determination unit 132 in addition to the functions of the reception unit 111, the selecting unit 112, the extraction unit 113, the transmit unit 114, the receive unit 115, and the output unit 116.

The first determination unit 131 determines the security level of the original data. The security level herein refers to the level of secrecy at which the original data is to be kept secret. The first determination unit 131 may determine the security level based on the character and image contained in the original data or determines the security level depending on whether the original data is encrypted or not. In the second operation example, the first determination unit 131 determines the security level based on a predetermined determination criterion. The security level determination criterion is stored on the memory 102.

FIG. 9 illustrates an example of a security level determination table. The security level determination table lists an item as to whether a particular image or a particular character is contained in the original data and an item as to whether the original data is encrypted or not. The particular image refers to an image that is to be attached to indicate a higher security level. For example, the particular image is a secret stamp or an internal use only stamp. The particular image is not necessarily visible to the user. The particular image may be an invisible image, such as a digital watermark. The particular characters are a predetermined type of character string, such as “internal use only”, or personal information (such as address, name, telephone number, mail address, and the like). The particular character and the particular image may be stepwise ranked in terms of security level. For example, “secret” has a security level higher than “internal use only”. If a variable character string, such as a telephone number or a mail address, (but with still some type of rule like including “@”), is used, the first determination unit 131 may determine the presence or absence of the character string through pattern matching.

The first determination unit 131 may determine the security level according to a form of the original data. For example, if the original data has a predetermined form, such as of ledger sheet, slip, or roster, the first determination unit 131 determines the security level according to the form. If the original data has a predetermined form, the first determination unit 131 may determine the security level to be higher. If multiple forms are present, the first determination unit 131 may set a different security level to each form. Note that the first determination unit 131 determines the security level by using these determination methods (using the particular character, the particular image, the encryption, and the form) in combination.

The second determination unit 132 determines the safety level of the cloud service. The safety level refers to the level of safety that is ensured in the use of the cloud service. In the present operation example, the safety level is determined by the safety of communications performed between the data processing apparatus 100 and the server apparatus 200. To this end, the second determination unit 132 determines the safety level of the service of each provider when the trial process is performed using the sample data, and then records the security level. The second determination unit 132 determines the safety level based on a predetermined safety determination criterion. The safety determination criterion is stored as a safety level determination table on the memory 102.

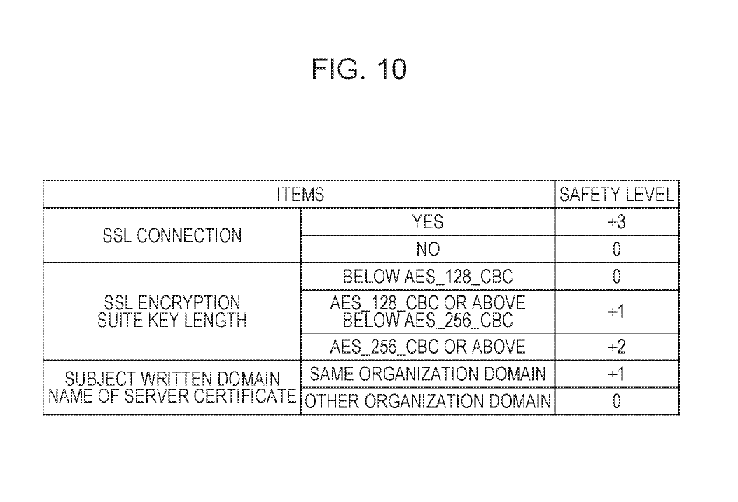

FIG. 10 illustrates an example of a safety level determination table. The safety level determination table lists safety levels responsive to secure socket layer (SSL) communications. The second determination unit 132 differentiates the safety level depending on whether the communication with the server apparatus 200 is SSL connection or not. If the communication is the SSL connection, the second determination unit 132 further differentiates the safety level based on SSL encryption suite key length and subject written domain name of server certificate. The second determination unit 132 calculates the safety level by adding a value of the safety level listed in the safety level determination table in accordance with the communication with the server apparatus 200. The safety level is not limited to the one thus calculated. The safety level may be specified by the user when the user registers the cloud service. Alternatively, the safety level may be acquired from another apparatus.

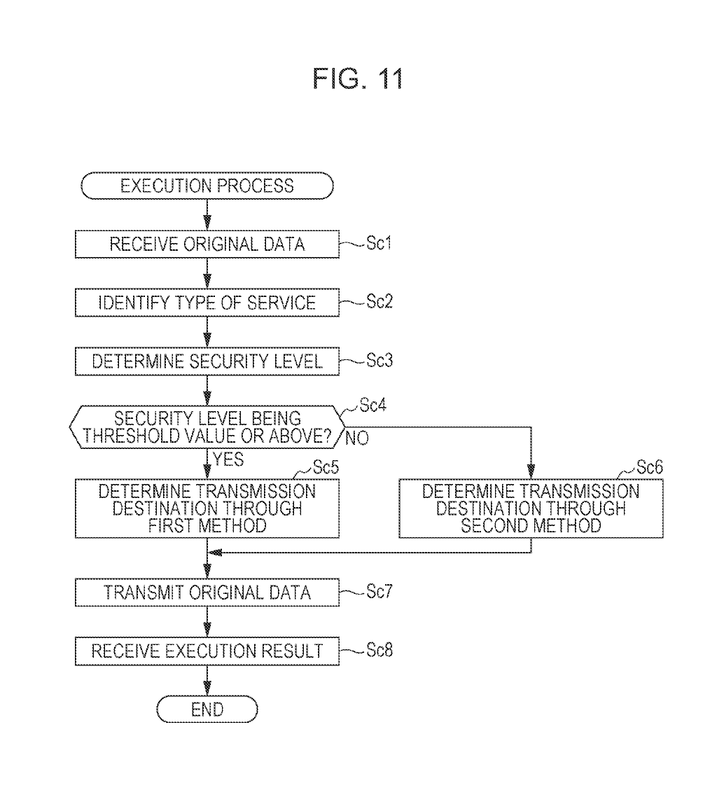

FIG. 11 is a flowchart illustrating an example of the execution process. Note that the trial process is executed in the same manner as in the first operation example, and the discussion thereof is omitted herein. When the execution process starts, the evaluation value of the cloud service has already been determined.

In the execution process, the controller 101 in the data processing apparatus 100 receives the original data from the user (step Sc1), and identifies the type of the cloud service to be executed (step Sc2). The operations in steps Sc1 and Sc2 are respectively identical to the operations in steps Sb1 and Sb2 in the first operation example (see FIG. 7).

The controller 101 determines the security level of the received original data (step Sc3). The controller 101 determines whether the security level obtained in step Sc3 is equal to or above a predetermined threshold value (first threshold value) (step Sc4). If the security level is equal to or above the first threshold value, the controller 101 determines that the security level of the original data is higher. The controller 101 then determines the transmission destination in a manner different depending on the security level of the original data as described below.

If the security level of the original data is higher, the controller 101 determines a server apparatus having a safety level satisfying a predetermined condition to be a transmission destination (step Sc5). For example, the controller 101 selects the transmission destination from among the server apparatuses 200 having a safety level equal to or above a predetermined threshold value (second threshold value). The controller 101 references the evaluation values and determines to be the transmission destination the server apparatus 200 having the highest evaluation value from among the server apparatuses 200 having a safety value equal to or above the second threshold value. The determination method in step Sc5 is herein referred to as a “first method”.

If the security level of the original data is not higher, the controller 101 determines the transmission destination in a second method different from the first method (step Sc6). For example, the controller 101 may determine the transmission destination based on only the evaluation value without accounting for the safety level. Alternatively, the controller 101 may determine as the transmission destination the server apparatus 200 having the highest evaluation value from among the server apparatuses 200 having a safety level equal to or above a third threshold value lower than the second threshold value.

Upon determining the transmission destination, the controller 101 transmits the original data to the determined transmission destination (step Sc7). The controller 101 then receives data indicating the execution result of the cloud service performed on the transmitted original data (step Sc8).

In this operation example, the evaluation value by the evaluation unit 122 is not necessarily used. For example, if the security level of the original data is higher, the controller 101 may determine the server apparatus 200 having the highest safety level to be the transmission destination without accounting for the evaluation value. Since the controller 101 is freed from referencing the evaluation value, the evaluation unit 122 is dispensed with.

In the second operation example, the transmission destination of the original data is different depending on the security level of the original data. The original data having a higher security level is less susceptible than the original data having a lower security level to unintended leaks of information contained in the original data as a result of the transmission of the original data to a transmission destination having a relatively lower safety level.

### Third Operation Example

In a third operation example, the sample data is extracted from the original data. The third operation example is different from the first operation example in that the user is freed from registering the sample data. In the third operation example, as well, the evaluation of the sample data described in the first operation example and the determination of the security level and the safety level described in the second operation example may be executed as appropriate, though not described in detail again herein.

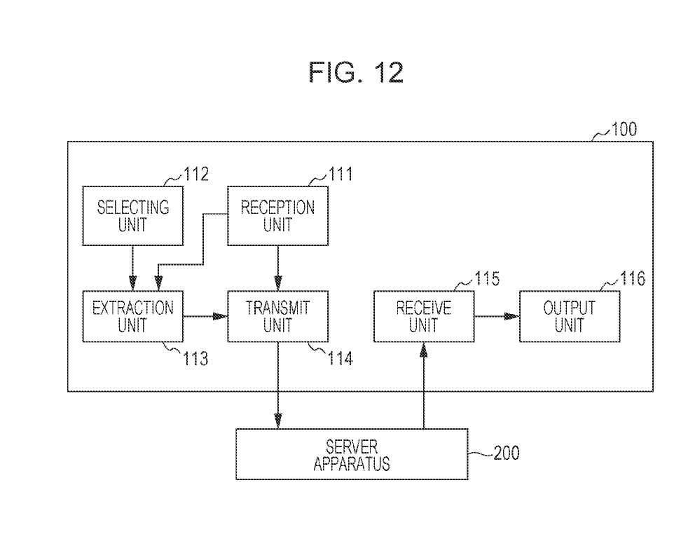

FIG. 12 is a functional flowchart illustrating the data processing apparatus 100 in the third operation example. The data processing apparatus 100 in the third operation example is different from the basic configuration of FIG. 3 in that the original data received by the reception unit 111 is supplied to the extraction unit 113 but identical to the basic configuration of FIG. 3 in the rest of the configuration.

In the third operation example, the extraction unit 113 extracts part of the original data as the sample data. The term part herein refers to any one page if the original data is a document of multiple pages. The term part does not necessarily mean data by page unit. The term part may be part of a document or a partial region of an image.

If there are multiple types of the provided cloud service, the extraction unit 113 desirably extracts the part responsive to the type of the service to be used by the user. For example, the extraction unit 113 divides the original data by page, calculates a feature quantity responsive to the type of the service on a page-by-page basis, and extracts the sample data in accordance with the calculated feature quantity.

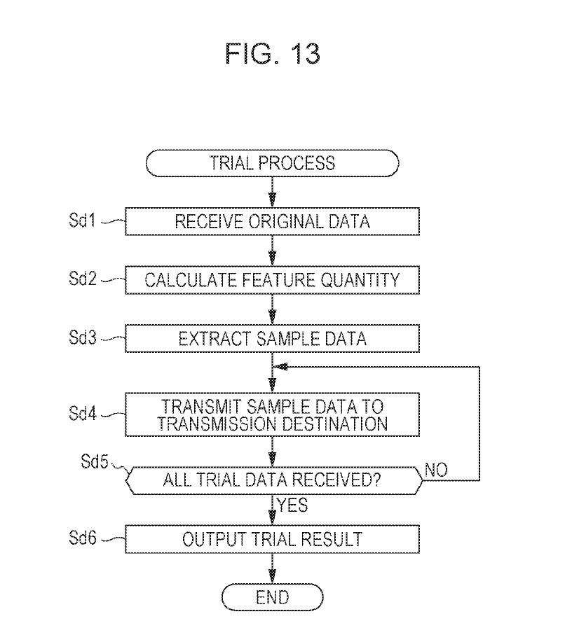

FIG. 13 is a flowchart illustrating an example of the trial process in the third operation example. In the trial process, the original data represents a document of multiple pages, and the sample data is one of the multiple pages. In the third operation example, the calculation method of the feature quantity is set to be different from type to type of the service.

In the trial process, the controller 101 in the data processing apparatus 100 receives the original data from the user (step Sd1). The controller 101 then calculates the feature quantity of the original data on each page (step Sd2). The calculation method of the feature quantity is described below.

If the cloud service to be performed is the “OCR service”, the controller 101 uses, as the feature quantity, ease with which a character is separated from the background. The feature quantity increases more as the separation of the character from the background is more difficult. The separation of the character from the background is typically more difficult as the contrast between the character and the background is smaller. The controller 101 thus extracts a page having a higher feature quantity, in other words, extracts a page presenting more difficulty in the separation of the character and the background, and uses the extracted page as the sample data. If a page presenting ease in the separation of the character from the background is set to be the sample data, a quality difference between the providers providing the OCR service is less noticeable.

The controller 101 may execute an easier OCR operation by using as the feature quantity the size of characters and the number of images contained on each page. Alternatively, the controller 101 may calculate the feature quantity using multiple different indexes, and use a combination of the indexes as a criterion of the extracting the sample data.

If the cloud service to be performed is the “translation service”, the controller 101 uses the line spacing and the number of characters as the feature quantity. If the source language is Japanese, the controller 101 may use as the feature quantity the number of or a rate of Kanji characters contained in part of (whole of) the page.

If the cloud service to be performed is the “difference detection service”, the controller 101 uses as the feature quantity a density or the number of elements from which a difference is to be detected, and a distance between the elements.

If the process to extract the sample data (such as calculating the feature quantity) is equivalent to a process to be executed in the cloud service, the use of the outside cloud service does not make much sense. The process to calculate the feature quantity is desirably simple. For example, the controller 101 may use a density (color density) of an entire image of each page represented by the original data as the feature quantity. If the original data contains characters (text data described in character codes), the controller 101 may use the number of characters on each page as the feature quantity.

Upon calculating the feature quantity, the controller 101 extracts the sample data in accordance with the calculated feature quantity (step Sd3). The controller 101 extracts the sample data more appropriate for the evaluation of the quality of the cloud service to be performed. The controller 101 transmits the extracted sample data to the transmission destination (namely the server apparatus 200) corresponding to the type of the cloud service to be performed (step Sd4). The controller 101 transmits the sample data to each transmission destination in the same manner as in the first operation example if there are multiple transmission destinations of the same service.

The controller 101 determines whether the trial data is received from all the transmission destinations to which the sample data has been transmitted (step Sd5). Upon receiving all the trial data, the controller 101 outputs the trial data (step Sd6). The outputting of the trial data may be the displaying of the display 104 or the image forming of the image forming unit 106. When the controller 101 outputs the trial data, the controller 101 may also output a character or an image indicating that the output trial data is a sample.

If the trial data is output, the user compares the trial results to select a transmission destination to be actually used (namely a provider). Upon receiving the selection of the user, the controller 101 transmits the original data to the transmission destination selected by the user to perform the execution process.

Referring to FIG. 13, the trial result is output in step Sd6. Instead of this operation, the controller 101 may evaluate the trial result. The evaluation in this case may be performed in the same manner as in the first operation example. This frees the user from having to evaluate the trial result.

In the third operation example, the sample data corresponding to the type of the service to be performed is extracted. The evaluation of the trial result is simple in comparison with the case in which the sample data is extracted regardless of the type of the service to be performed. Since the sample data is selected from the original data, the user more easily verifies the result of the service, and understands the contents of the service.

The data processing apparatus 100 may extract the sample data in response to an operation of the user. The data processing apparatus 100 may display the original data on a preview screen, and may allow the user to select which page to use as the sample data. Note that the data processing apparatus 100 extracts as the sample data the page selected by the user.

The exemplary embodiment has been described. The present invention is not limited to the exemplary embodiment and may be implemented in another exemplary embodiment. For example, the present invention may be implemented in the following modifications. The present invention may be implemented by using multiple modifications in combination, or by using the multiple operation examples in an appropriate combination.

The data processing apparatus does not necessarily have to be the image forming apparatus. The data processing apparatus may be an image reading apparatus having a communication function (image scanner), a personal computer, smartphone, or tablet terminal. The present invention is applicable to a data processing system including a data processing apparatus and a server apparatus, and a data processing method performed by the data processing apparatus.

A program to be executed by the controller 101 may be supplied in a recorded state on one of non-transitory computer readable recording media, including a magnetic recording medium (such as a magnetic tape or a magnetic disk), an optical recording medium (such as an optical disk), a magneto-optical recording medium, and a semiconductor memory. The program may be downloaded onto the data processing apparatus 100 via a communication medium such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data processing apparatus comprising:
an extraction unit that extracts trial data that is extracted from contents of original data and is responsive to a process to be provided;
a first transmission unit that transmits the trial data to a plurality of process providing units;
an evaluation unit that receives and evaluates trial results of processes that the process providing units have performed on the transmitted trial data; and
a selecting unit that selects from the plurality of process providing units a process providing unit that is to provide the process to the original data, according to an evaluation result by the evaluation unit.

2. The data processing apparatus according to claim 1, wherein the processes comprise a plurality of types of processes,
wherein the data processing apparatus includes a type selecting unit that selects the type of the process to be provided; and
wherein the extraction unit extracts the trial data responsive to the type selected by the type selecting unit.

3. The data processing apparatus according to claim 1, wherein the processes comprise a plurality of types of processes and a plurality of processes of same type is provided, and
wherein the extraction unit extracts the trial data common to the same type.

4. The data processing apparatus according to claim 2, wherein the processes comprise a plurality of types of processes and a plurality of processes of same type is provided, and
wherein the extraction unit extracts the trial data common to the same type.

5. The data processing apparatus according to claim 1, further comprising an output unit that outputs a trial result received by a receive unit.

6. The data processing apparatus according to claim 2, further comprising an output unit that outputs a trial result received by a receive unit.

7. The data processing apparatus according to claim 3, further comprising an output unit that outputs a trial result received by a receive unit.

8. The data processing apparatus according to claim 4, further comprising an output unit that outputs a trial result received by a receive unit.

9. The data processing apparatus according to claim 2, further comprising a registration unit that registers the process, wherein if a type of the process to be registered is new, the registration unit registers the new type of the process together with the trial data.

10. The data processing apparatus according to claim 3, further comprising a registration unit that registers the process, wherein if a type of the process to be registered is new, the registration unit registers the new type of the process together with the trial data.

11. The data processing apparatus according to claim 4, further comprising a registration unit that registers the process, wherein if a type of the process to be registered is new, the registration unit registers the new type of the process together with the trial data.

12. The data processing apparatus according to claim 9, wherein the registration unit registers the trial data together with criteria data representing a criterion to an execution result of the process performed on the trial data, and
wherein the evaluation unit evaluates the received trial result in accordance with the criteria data.

13. The data processing apparatus according to claim 12, further comprising a second transmit unit that transmits the original data to the process providing unit corresponding to the evaluation result of the evaluation unit if the same type of the process is provided by a plurality of process providing units.

14. The data processing apparatus according to claim 12, further comprising a measurement unit that measures time from transmission of the trial data to reception of the trial result,
wherein the evaluation unit evaluates the trial result received by the receive unit in accordance with the criteria data and the time measured by the measurement unit.

15. The data processing apparatus according to claim 1, further comprising:
a first determination unit that determines a security level of the original data;
a second determination unit that determines a safety level of the process on a per provider basis; and
a second transmit unit that transmits the original data to the provider responsive to the security level determined by the first determination unit and the safety level determined by the second determination unit.

16. The data processing apparatus according to claim 1, wherein the extraction unit extracts part of the original data as the trial data.

17. The data processing apparatus according to claim 16, wherein the original data represents a document of a plurality of pages,
wherein the extraction unit uses as the trial data a document of a page selected by a user from the document of the plurality of pages.

18. The data processing apparatus according to claim 16, wherein the processes comprise a plurality of types of processes, and
wherein the extraction unit extracts the part of the original data responsive to the type.

19. A data processing method comprising:
extracting trial data that is extracted from contents of original data and is responsive to a process to be provided;
transmitting the trial data to a plurality of process providing units;
receiving and evaluating trial results of processes that the process providing units have performed on the transmitted trial data; and
selecting from the plurality of process providing units a process providing unit that is to provide the original data, according to an evaluation result of the evaluating.

20. A non-transitory computer readable medium storing a program causing a computer to execute a process for processing data, the process comprising:
extracting trial data that is extracted from contents of original data and is responsive to a process to be provided;
transmitting the trial data to a plurality of process providing units;
receiving and evaluating trial results of processes that the process providing units have performed on the transmitted trial data; and
selecting from the plurality of process providing units a process providing unit that is to provide the original data, according to an evaluation result of the evaluating.
